(19) United States
(12) Patent Application Publication
(10) Pub. No.: US 2025/0003734 A1
(43) Pub. Date: Jan. 2, 2025

(54) MATERIAL MEASUREMENT SYSTEM AND METHOD

(71) Applicant: SAMSUNG ELECTRONICS CO., LTD., Suwon-si (KR)

(72) Inventors: Sungyoon Ryu, Suwon-si (KR); Ingi Kim, Suwon-si (KR); Suhwan Park, Suwon-si (KR); Inkeun Baek, Suwon-si (KR); Younghoon Sohn, Suwon-si (KR); Soobin Sinn, Suwon-si (KR); Yusin Yang, Suwon-si (KR); Sunhong Jun, Suwon-si (KR); Ikseon Jeon, Suwon-si (KR)

(21) Appl. No.: 18/639,332

(22) Filed: Apr. 18, 2024

(30) Foreign Application Priority Data
Jun. 29, 2023 (KR) 10-2023-0084530
Aug. 28, 2023 (KR) 10-2023-0113177

(51) Int. Cl. G01B 11/06

(52) U.S. Cl. CPC G01B 11/06

(57) ABSTRACT

A measuring system measures an overall resistance of two or more films on a substrate/measurement object by a terahertz absorption measurement and an overall film thickness by a photoacoustic measurement. The system estimates a first film thickness based on the overall resistance, then subtracts this estimated thickness from the overall film thickness measured by the photoacoustic measurement. The system includes a source unit to output a laser beam. A first pump-probe unit receives the laser beam and performs a photoacoustic test on the measurement object. A second pump-probe unit receives the laser beam and performs a terahertz signal test on the measurement object. The system also includes a stage to support the measurement object and controls for controlling elements and calculating the film thicknesses

### CROSS-REFERENCE TO RELATED APPLICATION

This application claims priority under 35 U.S.C. § 119 to Korean Patent Applications Nos. 10-2023-0084530 and 10-2023-0113177, respectively filed on Jun. 29, 2023 and Aug. 28, 2023, in the Korean Intellectual Property Office, the disclosures of which are incorporated by reference herein in their entireties.

### BACKGROUND

As electronic products need to become more compact, multi-functional, and highly efficient, semiconductor memory devices need to have larger capacity. Because the integration density of conventional two-dimensional (2D) semiconductor memory device is mainly determined by a reduction of an area occupied by a unit memory cell, the integration density of semiconductor devices is gradually increasing.

Accordingly, a method of monitoring each process operation of a semiconductor manufacturing process has been needed. To this end, a non-destructive test with high inspection speed is imperatively required.

### SUMMARY

The present disclosure provides a measuring system with improved reliability, a measuring method, and a method of manufacturing a semiconductor device using the system and method.

According to an aspect of the present disclosure, there is provided a measuring system including a source unit configured to generate and output a laser beam, a first pump-probe unit configured to receive the laser beam and perform a photoacoustic test on a measurement object, a second pump-probe unit configured to receive the laser beam and perform a terahertz signal test on the measurement object and a stage configured to support the measurement object.

According to another aspect of the present disclosure, there is provided a measuring system including a source unit configured to generate and output a laser beam including a first laser beam and a second laser beam, a first pump-probe unit configured to receive the first laser beam and perform a photoacoustic test on a measurement object, a second pump-probe unit configured to receive the second laser beam and perform a terahertz signal test on the measurement object, and a stage configured to support the measurement object, wherein the first laser beam includes a first pump laser beam and a first probe laser beam, the second laser beam includes a second pump laser beam and a second probe laser beam, and the second pump-probe unit includes a first time-difference generator configured to delay the second pump laser beam.

According to another aspect of the present disclosure, there is provided a measuring method including generating a laser beam, splitting the laser beam into a first laser beam and a second laser beam, performing a photoacoustic test on a measurement object by using the first laser beam, performing a terahertz signal test on the measurement object by using the second laser beam, and measuring a thickness of each of a plurality of meal films of the measurement object.

### BRIEF DESCRIPTION OF THE DRAWINGS

Embodiments of the present disclosure will be more clearly understood from the following detailed description taken in conjunction with the accompanying drawings in which:

FIG. 1 is a block diagram of a measuring device;

FIG. 2 is a conceptual diagram of the measuring system of FIG. 1;

FIG. 3 is a conceptual diagram of behaviors of a first laser beam and a second laser beam;

FIGS. 4A and 4B are graphs of signals for a first laser beam and a second laser beam, respectively;

FIG. 5 is a diagram of a plurality of material layers formed on a wafer;

FIG. 6 is a cross-sectional view of a semiconductor device including a plurality of metal films;

FIG. 7 is a flowchart of a method of measuring a wafer by using a measuring system;

FIG. 8 is a flowchart of a method of measuring a thickness of each of a plurality of metal films; and

FIG. 9 is a flowchart of a method of manufacturing a semiconductor device, which includes a method of measuring a wafer by using a measuring system.

### DETAILED DESCRIPTION OF THE EMBODIMENTS

Hereinafter, implementations will be described in detail with reference to the accompanying drawings. The same reference numerals are used to denote the same elements in the drawings, and repeated descriptions thereof are omitted.

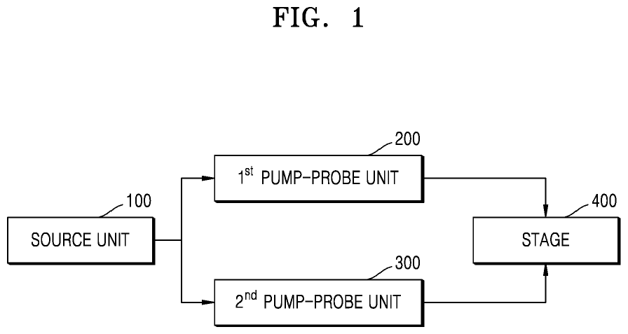

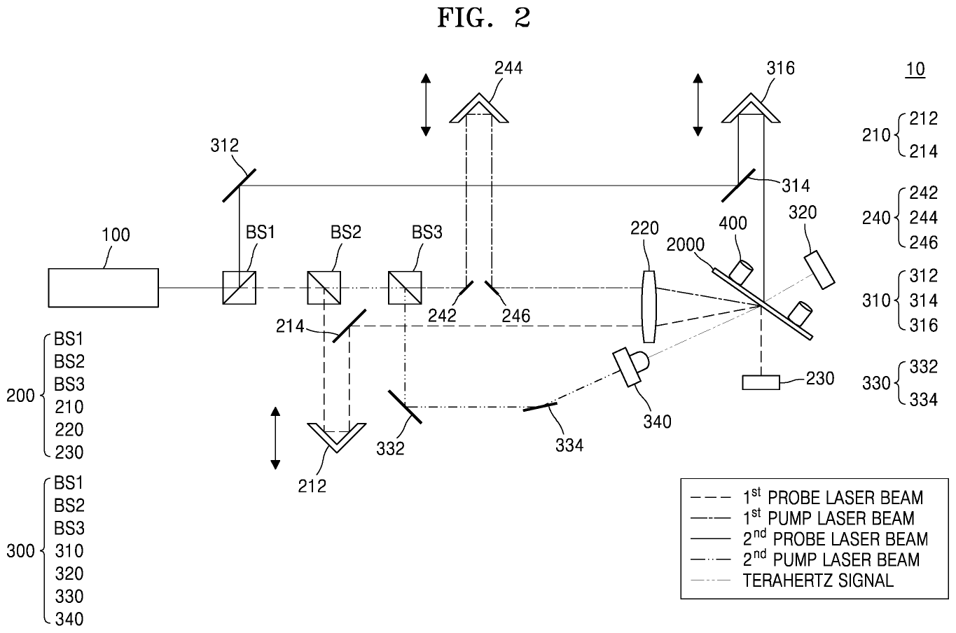

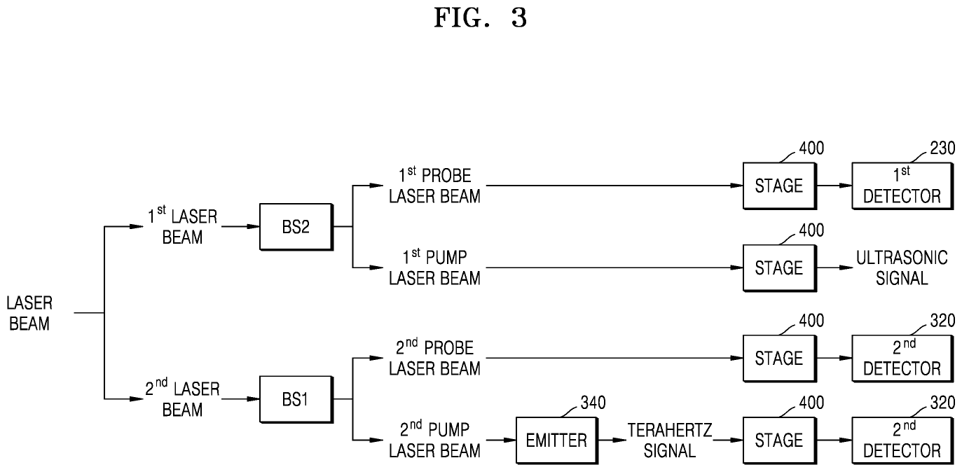

FIG. 1 is a block diagram of an example of a measuring system, and FIG. 2 is a conceptual diagram of the measuring system of FIG. 1. FIG. 3 is a conceptual diagram of the behaviors of a first laser beam and a second laser beam.

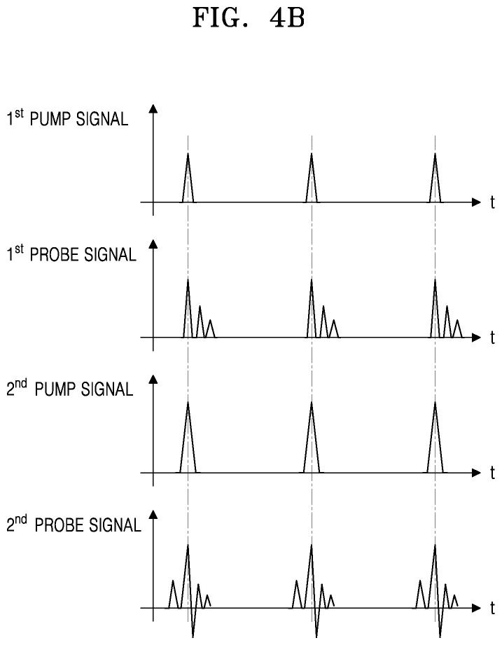

Referring to FIGS. 1 to 3, a measuring system 10 may include a source unit 100, a first pump-probe unit 200, a second pump-probe unit 300, and a stage 400. The measuring system 10 may be used to test a test object, such as a wafer 2000. For example, the measuring system 10 may be used to test a plurality of material layers formed on the wafer 2000. For example, the plurality of material layers may include a plurality of metal films (refer to ML in FIG. 5). For example, the measuring system 10 may be used to non-destructively test a test object, such as the wafer 2000. The measuring system 10 may be used to perform a photoacoustic test (e.g., an ultrasonic test) and a terahertz signal test.

In the photoacoustic test, an optical signal may be transmitted to a test object (e.g., the wafer 2000), and an acoustic signal generated by the test object (e.g., the wafer 2000) in response to the optical signal may be sensed. A portion of the test object (e.g., the wafer 2000), which absorbs the optical signal, may expand due to a rise in temperature. In this case, the optical signal may be a pulse or a pulse train, and a length of an individual pulse may need to be shorter than a characteristic time of heat diffusion caused by the optical signal. This restriction may be called thermal confinement. Pressure waves may be generated by a rapid expansion of the portion of the wafer 2000 due to the absorption of the optical signal. As a result, an acoustic signal in an ultrasonic frequency band may be generated. Ultrasonic waves may have a high transmittance and a low propagation rate inside a metal and/or a semiconductor material. Accordingly, a thickness of the metal and/or the semiconductor material may be measured in the photoacoustic test with high reliability.

In the terahertz signal test, a terahertz signal may be transmitted to a test object (e.g., the wafer 2000), and a terahertz signal, which is absorbed, reflected, transmitted, and/or refracted inside the test object (e.g., the wafer 2000), may be received, and information about the test object may be sensed. Because a metal and/or a semiconductor material has a conductivity resonance phenomenon where electrical conductivity of the metal and/or the semiconductor material markedly increases when influenced by a terahertz frequency band signal, a resistance of the metal and/or the semiconductor material may be measured in the terahertz signal test with high reliability.

The source unit 100 may generate and output a pulse laser beam. For example, the source unit 100 may include a neodymium:yttrium aluminum garnet (Nd:YAG) laser oscillator. For instance, the source unit 100 may generate and output a femtosecond (fs) laser beam. The laser beam may have a pulse length of about 0.1 fs to about 200 fs. However, the pulse length of the laser beam is not limited to the above-described range.

Moreover, the laser beam may have a visible and/or infrared wavelengths. For example, the laser beam may have visible and/or near infrared ray (NIR) wavelengths. In the measuring system 10 according to the present implementation, the laser beam generated by the source unit 100 may have a wavelength of about 300 nm to about 2000 nm.

The laser beam may include a first laser beam and a second laser beam. The first laser beam may be a laser beam for a photoacoustic test, and the second laser beam may be a laser beam for a terahertz signal test. The first laser beam may be incident on the first pump-probe unit 200, and the second laser beam may be incident on the second pump-probe unit 300.

Also, the first laser beam may include a first pump laser beam and a first probe laser beam, and the second laser beam may include a second pump laser beam and a second probe laser beam. The first probe laser beam may act as a reference beam of the first laser beam, and the second probe laser beam may act as a reference beam of the second laser beam. Here, a reference beam may refer to a laser beam used to measure and/or detect an ultrasonic signal or a terahertz signal as described below.

The first pump-probe unit 200 may be a component for a photoacoustic test on a test object, such as the wafer 2000. The first pump-probe unit 200 may include a first beam splitter BS1, a second beam splitter BS2, a third beam splitter BS3, a first time-difference generator 210, an object lens 220, a first detector 230, and a second time-difference generator 240.

The first laser beam may be transmitted through the first beam splitter BS1. The first laser beam may be split by the second beam splitter BS2. For example, the second beam splitter BS2 may allow part of the first laser beam to enter the first time-difference generator 210. Also, the second beam splitter BS2 may allow the remaining part of the first laser beam to enter the third beam splitter BS3. The first laser beam input from the second beam splitter BS2 to the first time-difference generator 210 may be the first probe laser beam, and the first laser beam input from the second beam splitter BS2 to the third beam splitter BS3 may be the first pump laser beam.

To begin with, a behavior of the first probe laser beam is described. The first probe laser beam may be incident on the first time-difference generator 210. The first time-difference generator 210 may delay and/or adjust a time taken for the first probe laser beam to enter the first detector 230. The first time-difference generator 210 may include a plurality of optical mirrors. For example, the first time-difference generator 210 may include a first optical mirror 212 and a second optical mirror 214. The first time-difference generator 210 may adjust a delay time of the first probe laser beam by linearly moving the first optical mirror 212. Also, the second optical mirror 214 may allow the first probe laser beam reflected by the first optical mirror 212 to enter the object lens 220. It is clear that the number and arrangement of optical mirrors in the first time-difference generator 210 may vary according to the arrangement of the second beam splitter BS2 and the object lens 220.

The object lens 220 may focus the first probe laser beam onto the wafer 2000, which is a measurement object. The object lens 220 may illuminate the wafer 2000 by condensing the first probe laser beam reflected by the second optical mirror 214 into a point shape. For example, the object lens 220 may be a refractive object lens of high magnification or a high numerical aperture (NA).

The first probe laser beam, which has passed through the object lens 220, may be reflected by the wafer 2000 and then incident on the first detector 230. The first detector 230 may generate an electrical signal in response to the first probe laser beam. An intensity, a phase, and/or a frequency of the first probe laser beam may be changed according to an ultrasonic signal generated in the wafer 2000. More specifically, the intensity, phase, and/or frequency of the first probe laser beam may be changed according to a phase of ultrasonic waves generated by the wafer 2000. Accordingly, the first detector 230 may detect the first probe laser beam and measure the phase of the ultrasonic waves generated by the wafer 2000. The phase of the ultrasonic waves may be changed according to a thickness T of the metal film (refer to ML in FIG. 5) of the wafer 2000. As a result, the first detector 230 may measure the thickness T of the metal film ML.

Next, a behavior of the first pump laser beam is described. The first pump laser beam, which has been transmitted through the second beam splitter BS2, may be incident on the third beam splitter BS3. The first pump laser beam may be transmitted through the third beam splitter BS3 and incident on the second time-difference generator 240.

The second time-difference generator 240 may delay and/or adjust a time taken for the first pump laser beam to enter the first detector 230. The second time-difference generator 240 may offset the first pump laser beam and the second pump laser beam. The measuring system 10 may measure the wafer 2000 by using each of the first laser beam and the second laser beam, which are different from each other, and thus, a peak of the first laser beam and a peak of the second laser beam may be spaced apart from each other in a temporal sequence. Accordingly, the second time-difference generator 240 may offset the first laser beam and the second laser beam by delaying the first laser beam (e.g., the first pump laser beam).

In still another implementation, the second time-difference generator 240 may synchronize the first pump laser beam with the second pump laser beam. When the first pump laser beam is synchronized with the second pump laser beam, the measuring system 10 may easily control the first laser beam and the second laser beam.

The second time-difference generator 240 may include a plurality of optical mirrors. The second time-difference generator 240 may include a third optical mirror 242, a fourth optical mirror 244, and a fifth optical mirror 246. The third optical mirror 242 may allow the first pump laser beam, which has been transmitted through the third beam splitter BS3, to enter the fourth optical mirror 244. The second time-difference generator 240 may adjust a delay time of the first pump laser beam by linearly moving the fourth optical mirror 244. It should be clear that the number and arrangement of optical mirrors in the second time-difference generator 240 may vary according to the arrangement of the third beam splitter BS3 and the object lens 220.

The first pump laser beam may be delayed and/or adjusted by the second time-difference generator 240, and the first probe laser beam may be delayed and/or adjusted by the first time-difference generator 210. Thus, a delay period of the first probe laser beam may be adjusted according to the first pump laser beam that is delayed and/or adjusted by the second time-difference generator 240.

The first pump laser beam reflected by the fourth optical mirror 244 may be reflected on the object lens 220 by the fifth optical mirror 246. As described above, the object lens 220 may focus the first pump laser beam to the wafer 2000, which is a measurement object. The object lens 220 may illuminate the wafer 2000 by condensing the first pump laser beam into a point shape.

The first pump laser beam, which has been transmitted through the object lens 220, may be incident on the wafer 2000. When the first pump laser beam is incident on the wafer 2000, an ultrasonic signal may be generated by the wafer 2000 in response to the first pump laser beam. The intensity, phase, and/or period of the first probe laser beam may be changed due to the generated ultrasonic signal. Although not shown, the first pump laser beam reflected by the wafer 2000 may be incident on a component other than the first detector 230 and separated from the first probe laser beam. Thus, the first detector 230 may not receive the first pump laser beam, but the first probe laser beam.

As described above, the intensity, phase, and/or period of the first probe laser beam may be changed due to the ultrasonic waves generated by the wafer 2000. Accordingly, the first detector 230 may measure a thickness of the wafer 2000, based on the intensity, phase, and/or period of the detected first probe laser beam.

The second pump-probe unit 300 may be a component for a terahertz signal test on a test object, such as the wafer 2000. The second pump-probe unit 300 may include the first beam splitter BS1, the second beam splitter BS2, the third beam splitter BS3, a third time-difference generator 310, a second detector 320, a mirror element 330, and an emitter 340. The first beam splitter BS1, the second beam splitter BS2, and the third beam splitter BS3 may be components of the first pump-probe unit 200 and also be components of the second pump-probe unit 300.

The second laser beam may be split by the first beam splitter BS1. For example, the first beam splitter BS1 may allow part of the second laser beam to enter the third time-difference generator 310. Also, the first beam splitter BS1 may allow the remaining part of the first laser beam to enter the second beam splitter BS2. The second laser beam reflected by the first beam splitter BS1 may be the second probe laser beam, and the second laser beam transmitted through the first beam splitter BS1 may be the second pump laser beam. Herein, the second probe laser beam may act as a reference beam of the second laser beam. Herein, a reference beam may refer to a laser beam used to detect the second laser beam as described below.

To begin with, a behavior of the second probe laser beam is described. The second probe laser beam reflected by the first beam splitter BS1 may be incident on the third time-difference generator 310.

The third time-difference generator 310 may delay and/or adjust a time taken for the second probe laser beam to enter the second detector 320. The third time-difference generator 310 may include a plurality of optical mirrors. For example, the third time-difference generator 310 may include a sixth optical mirror 312, a seventh optical mirror 314, and an eighth optical mirror 316. The third time-difference generator 310 may adjust a delay time of the second probe laser beam by linearly moving the eighth optical mirror 316. The sixth optical mirror 312 may allow the second probe laser beam reflected by the first beam splitter BS1 to enter the seventh optical mirror 314. Also, the eighth optical mirror 316 may allow the second probe laser beam reflected by the seventh optical mirror 314 to enter the wafer 2000. It should be clear that the number and arrangement of optical mirrors in the third time-difference generator 310 may vary according to the arrangement of the first beam splitter BS1 and the stage 400.

The second probe laser beam, which has been transmitted through the third time-difference generator 310, may be incident on the wafer 2000 and then incident on the second detector 320. The second detector 320 may generate an electrical signal in response to the second probe laser beam. For example, the second detector 320 may be turned on and off in response to the second probe laser beam. As described below, the second detector 320 may generate an electrical signal in response to each of the second probe laser beam and a terahertz signal.

Although the second probe laser beam is illustrated as being incident to a bottom surface of the wafer 2000 in FIG. 2, it should be clear that the second probe laser beam may be incident on a top surface of the wafer 2000.

Next, a behavior of the second pump laser beam is described. The second pump laser beam, which has been transmitted through the first beam splitter BS1, may be incident on the second beam splitter BS2. The second pump laser beam may be transmitted through the second beam splitter BS2 and incident on the third beam splitter BS3. The second pump laser beam, which has been incident on the third beam splitter BS3, may be incident on an emitter 340 through an optical element 330.

That is, the optical element 330 may allow the second pump laser beam to enter the emitter 340. The optical element 330 may include, for example, at least one optical mirror. For example, the optical element 330 may include a ninth optical mirror 332 and a tenth optical mirror 334. It should be clear that the number and arrangement of optical mirrors in the optical element 330 may vary according to the arrangement of the third beam splitter BS3 and the emitter 340.

The emitter 340 may receive the second pump laser beam and generate a terahertz (THz) signal. The terahertz signal generated by the emitter 340 may be input to the wafer 2000. When the second pump laser beam is irradiated to the emitter 340, charge carriers may be generated by the emitter 340, and electromagnetic radiation (i.e., the terahertz signal) of the charge carriers may be generated in a differential form. The second pump laser beam may be synchronized with the terahertz signal.

At least part of the terahertz signal input to the wafer 2000 may be absorbed into the wafer 2000. The second detector 320 may detect the terahertz signal and measure an absorption rate of the terahertz signal. The absorption rate may be calculated by using a ratio of the intensity of the terahertz signal absorbed by the second detector 320 to the intensity of the terahertz signal generated by the emitter 340. For example, the terahertz signal transmitted through the wafer 2000 may be detected by the second detector 320. In still other implementations, the second detector 320 may detect a terahertz signal reflected by the wafer 2000.

The second detector 320 may obtain a pump-probe THz absorption (PPTA), based on a difference in absorption rate between detected terahertz signals. Also, the second detector 320 may calculate a resistance of the wafer 2000 at a measurement position, based on the PPTA.

In yet other implementations, the second pump-probe unit 300 may further include an optical chopper and a lock-in-amplifier. The optical chopper, which is a device configured to control a laser beam, may periodically control the second pump laser beam. The optical chopper may exclude a terahertz signal in conjunction with the lock-in-amplifier installed in the second detector 320. In other words, the optical chopper, together with the lock-in-amplifier, may allow the terahertz signal to be selectively detected.

The stage 400 may support the wafer 2000, which is a test object. For example, the stage 400 may include a wafer chuck. For example, the stage 400 may include a 3-point wafer chuck and/or a hole-type wafer chuck.

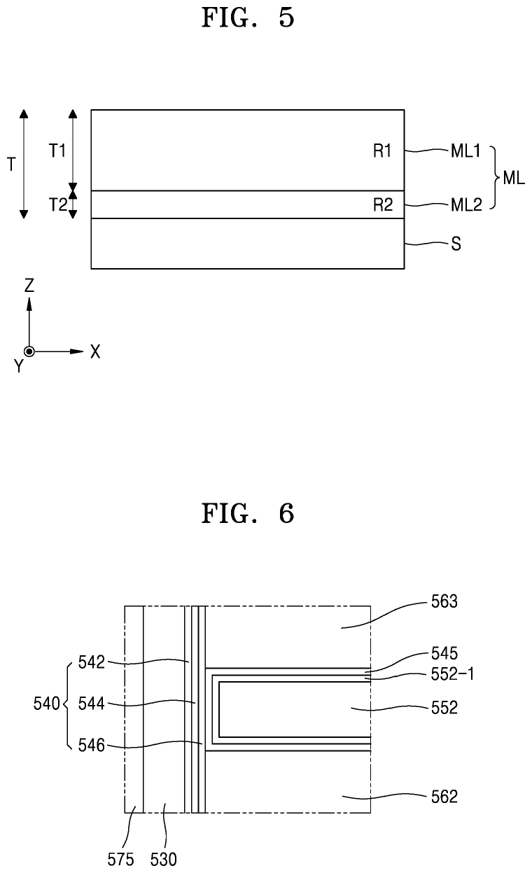

The wafer 2000, which is a test object, may include a plurality of material layers. For example, the wafer 2000 may include a plurality of metal films (refer to ML in FIG. 5). The plurality of material layers included in the wafer 2000 are described below in detail with reference to FIGS. 5 and 6.

Although not shown, the measuring system 10 may further include a controller and a processor. The controller may be configured to control operations of the source unit 100, the first time-difference generator 210, the second time-difference generator 240, the third time-difference generator 310, the first detector 230, and the second detector 320. The controller may be configured to generate signals for controlling oscillation of the source unit 100, respective behaviors of the first time-difference generator 210, the second time-difference generator 240, and the third time-difference generator 310, and on/off operations of the first detector 230 and the second detector 320.

The processor may be configured to process electrical signals obtained by the first detector 230 and the second detector 320. For instance, the processor may preprocess measurement data including the electrical signals obtained by the first detector 230 and the second detector 320 and measure the thickness T of the metal film ML, based on the intensity, period, and/or frequency of the first probe laser beam. Also, the processor may measure the resistance R of the metal film ML based on an absorption rate of a terahertz signal. In addition, the processor may approximate the resistance R of the metal film ML to a first resistance R1, calculate a first thickness T1 based on the first resistance R1, and calculate a second thickness T2 based on the first thickness T1 and on the measured thickness T.

In implementations, each of the controller and the processor may be implemented as hardware, firmware, software, or an arbitrary combination thereof. For instance, each of the controller and the processor may include a computing device, such as a workstation computer, a desktop computer, a laptop computer, and a tablet computer. Each of the controller and the processor may include a simple controller, a microprocessor, a complex processor (e.g., a central processing unit (CPU) and a graphics processing unit (GPU)), a process configured by software, or dedicated hardware or firmware. Each of the controller and the processor may be implemented as, for example, a general-purpose computer or application-specific hardware, such as a digital signal processor (DSP), a field programmable gate array (FPGA), and an application specific integrated circuit (ASIC).

In some implementations, operations of the controller and the processor may be implemented as commands stored on a machine-readable medium that may be read and executed by at least one processor. Here, the machine-readable medium may include arbitrary mechanism for storing and/or transmitting information in a form readable by a machine (e.g., a computing device). For example, the machine-readable medium may include read-only memory (ROM), random access memory (RAM), magnetic disk storage media, optical storage media, flash memory devices, electrical, optical, acoustic, or other forms of radio signals (e.g., carrier waves, infrared signals, digital signals, etc.), and other arbitrary signals.

The above-described operations of the controller and the processor or any process described below may include firmware, software, routines, and/or instructions. However, for brevity, the operations of the controller and the processor may result from other devices configured to execute a computing device, a processor, firmware, software, routines, and instructions.

A typical measuring system performs only one of a photoacoustic test and a terahertz signal test on a measurement object. The photoacoustic test has a relatively low sensitivity to a resistance of the measurement object, but a relatively high sensitivity to a thickness of the measurement object. Conversely, the terahertz signal test has a relatively high sensitivity to a resistance of the measurement object, but a relatively low sensitivity to a thickness of the measurement object.

However, the measuring system 10 may simultaneously perform a photoacoustic test and a terahertz signal test on a measurement object. Accordingly, the measuring system 10 may have relatively high sensitivity to both a resistance and a thickness of the measurement object.

Also, the measuring system 10 may offset the first laser beam and the second laser beam to prevent the first laser beam for the photoacoustic test and the second laser beam for the terahertz signal test from interfering with each other.

In addition, to easily control a laser beam, the measuring system 10 may synchronize the first laser beam for the photoacoustic test with the second laser beam for the terahertz signal test.

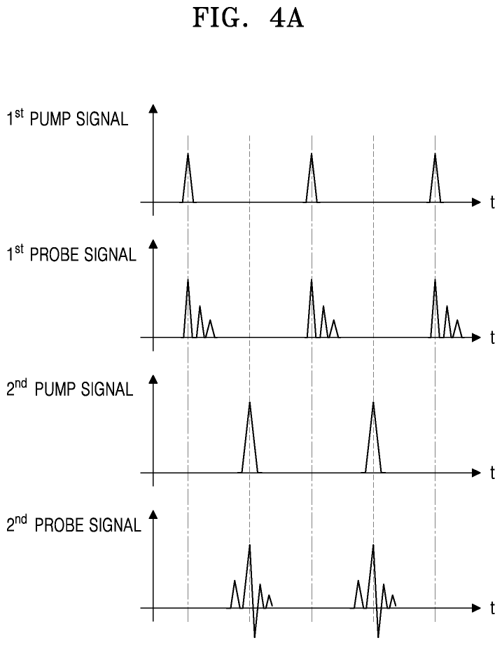

FIGS. 4A and 4B are graphs of signals for a first laser beam and a second laser beam. The graphs of FIGS. 4A and 4B are described with reference to FIGS. 1 to 3.

Referring to FIGS. 4A and 4B, the graphs show, from top to bottom, a change of a first pump laser beam over time, a change of a first probe laser beam over time, a change of a second pump laser beam over time, and a change of a second probe laser beam over time. In each graph, the vertical axis represents a relative signal intensity, the horizontal axis represents time, and the graphs are aligned with each other such that the same position on the horizontal axis represents the same time.

An intensity of the first laser beam and an intensity of the second laser beam may each have the shape of a periodic function. Because a laser beam generated by a source unit 100 is split into the first pump laser beam, the first probe laser beam, the second pump laser beam, and the second probe laser beam, a waveform of the first pump laser beam, a waveform of the first probe laser beam, a waveform of the second pump laser beam, and a waveform of the second probe laser beam may substantially have the same period.

To begin with, as shown in FIG. 4A, the waveform of the first pump laser beam and the waveform of the first probe laser beam may be synchronized with each other. As used herein, the synchronization of two waveforms may refer to the formation of respective (main) peaks of the two waveforms at substantially the same time. To synchronize the waveform of the first pump laser beam with the waveform of the first probe laser beam, a first time-difference generator 210 may delay and/or adjust the first probe laser beam.

As described above, an ultrasonic signal may be generated by the first pump laser beam. The ultrasonic signal may be synchronized with the first pump laser beam. Accordingly, when the first pump laser beam is synchronized with the first probe laser beam, the first probe laser beam may be synchronized with the ultrasonic signal.

Also, the waveform of the second pump laser beam may be synchronized with the waveform of the second probe laser beam. To synchronize the waveform of the second pump laser beam with the waveform of the second probe laser beam, the third time-difference generator 310 may delay and/or adjust the second probe laser beam.

Also, the waveform of the first laser beam and the waveform of the second laser beam may be offset. As used herein, when two waveforms are offset, respective peaks of the two waveforms may be referred to as being temporally spaced apart from each other. To offset the first laser beam and the second laser beam, a second time-difference generator 240 may delay and/or adjust the first pump laser beam.

As described above, a terahertz signal may be generated by the second pump laser beam. The terahertz signal may be synchronized with the second pump laser beam. Thus, when the second pump laser beam is offset by the first pump laser beam, the terahertz signal may also be offset by the first pump laser beam.

Because the measuring system 10 measures the wafer 2000 as a measurement object by using the first laser beam and the second laser beam, which are different from each other, the first laser beam may be temporally spaced from the second laser beam. Accordingly, the measuring system 10 may measure the wafer 2000 with high reliability.

As shown in FIG. 4B, the first laser beam and the second laser beam may be synchronized with each other. The second time-difference generator 240 may delay and/or adjust the first pump laser beam such that the first laser beam and the second laser beam are synchronized with each other.

Therefore, the measuring system 10 may simultaneously receive the respective signals for the first laser beam and the second laser beam. Because the first laser beam is synchronized with the second laser beam, the measuring system 10 may easily control each of the first laser beam and the second laser beam.

FIG. 5 is a diagram of a plurality of material layers formed on a wafer. FIG. 5 is described with reference to FIGS. 1 to 3.

Referring to FIG. 5, a wafer 2000, which is a measurement object, may include a substrate S and a metal film ML. The metal film ML may be formed on the substrate S. The substrate S may be a semiconductor substrate including a semiconductor material, such as single-crystalline silicon or single-crystalline germanium. For example, the substrate S may further include silicon (Si), germanium (Ge), or a compound semiconductor, such as silicon-germanium (Si—Ge).

The metal film ML may include a plurality of different layers. The metal film ML may include, for example, a first metal film ML1 and a second metal film ML2. For instance, the first metal film ML1 may include a bulk metal, and the second metal film ML2 may include a barrier metal. For example, the first metal film ML1 may include titanium (Ti), tantalum (Ta), tungsten (W) and/or aluminum (Al), and the second metal film ML2 may include tungsten nitride (WN), tantalum nitride (TaN), or titanium nitride (TiN) and/or tungsten silicide (WSi).

The first metal film ML1 may have a first thickness T1 in a vertical direction (Z direction), and the second metal film ML2 may have a second thickness T2 in the vertical direction (Z direction). Accordingly, a thickness T of the metal film ML in the vertical direction (Z direction) may be determined by the sum of the first thickness T1 and the second thickness T2.

As used herein, a direction parallel to a main surface of the wafer 2000 may be defined as a lateral direction (X direction and/or Y direction), and a direction perpendicular to the lateral direction (X direction and/or Y direction) may be defined as the vertical direction (Z direction).

Also, the first metal film ML1 may have a first resistance R1, and the second metal film ML2 may have a second resistance R2. In general, the first thickness T1 of the first metal film ML1 may be much greater than the second thickness T2 of the second metal film ML2 (T1>>T2). When the first thickness T1 of the first metal film ML1 is much greater than the second thickness T2 of the second metal film ML2, the first resistance R1 of the first metal film ML1 may be much greater than the second resistance R2 of the second metal film ML2 (R1>>R2). When the first resistance R1 of the first metal film ML1 is much higher than the second resistance R2 of the second metal film ML2, a resistance R of the metal film ML may be approximated to the first resistance R1. That is, the resistance R of the metal film ML may be approximated by the following equation:

$$R = R 1 + R 2 \approx R 1 ( where , R 1 >> R 2 ) \qquad [ Equation ]$$

wherein R denotes a resistance of the metal film ML, R1 denotes a first resistance of the first metal film ML1, and R2 denotes a second resistance of the second metal film ML2.

As described above, the measuring system 10 may perform a photoacoustic test and a terahertz signal test on the wafer 2000. That is, the measuring system 10 may perform a photoacoustic test and a terahertz signal test on the metal film ML. The thickness T of the metal film ML may be measured via the photoacoustic test, and the resistance R of the metal film ML may be measured via the terahertz signal test.

As described above, the resistance R of the metal film ML may be approximated to the first resistance R1 of the first metal film ML1. In addition, because it is known that resistance and thickness have a linear proportional relationship, when the first resistance R1 is derived, the first thickness T1 may be calculated by using the proportional relationship. As a result, the second thickness T2 of the second metal film ML2 may be calculated based on a difference between the thickness T of the metal film ML and the first thickness T1 of the first metal film ML1.

A typical measuring system has high sensitivity for measuring a total thickness of a plurality of metal films, but relatively low sensitivity for measuring a thickness of each of the plurality of metal films. Accordingly, it is difficult for the typical measuring system to precisely determine the thickness of each of the plurality of metal films.

Conversely, the measuring system 10 may measure both a total thickness and a total resistance of a plurality of metal films. Thereafter, the total resistance may be approximated to the first resistance R1 of the first metal film ML1, and the first thickness T1 of the first metal film ML1 may be then calculated by using the proportional relationship between resistance and thickness. By using the above-described process, the first thickness T1 and the second thickness T2 may be precisely calculated. Therefore, a highly reliable semiconductor device may be manufactured by using the measuring system 10.

FIG. 6 is a cross-sectional view of a semiconductor device including a plurality of metal films. The semiconductor device of FIG. 6 is described with reference to FIGS. 1 to 5.

Referring to FIG. 6, a semiconductor device SD may include, for example, a memory device. For example, the semiconductor device SD may include a volatile memory cell, a non-volatile memory cell and/or a logic cell. For example, the semiconductor device SD may include a dynamic random access memory (DRAM) cell, a static RAM (SRAM) cell, a flash memory cell (e.g., a NAND memory cell), and/or logic cell.

The semiconductor device SD may include a channel region 530, a gate dielectric film 540, a gate electrode 552, an interlayer insulating films 562 and 563, and a buried insulating film 575.

FIG. 6 illustrates an enlargement of the channel region 530 that may be used as a channel of memory cell strings. The buried insulating film 575 may be on a left side surface of the channel region 530. The gate dielectric film 540 may be on a right side surface of the channel region 530.

The gate dielectric film 540 may have a structure in which a tunneling insulating film 542, a charge storage film 544, and a blocking insulating film 546 are sequentially stacked on the right side surface of the channel region 530.

The tunneling insulating film 542 may include a single layer or a compound layer, which include at least one of silicon oxide (SiO₂), silicon nitride (Si₃N₄), silicon oxynitride (SiON), hafnium oxide (HfO₂), hafnium silicon oxide (HfSiₓO_{y}), aluminum oxide (Al₂O₃), and zirconium oxide (ZrO₂).

The charge storage film 544 may be a charge trap layer. When the charge storage film 544 is the charge trap layer, the charge storage film 544 may include at least one of silicon oxide (SiO₂), silicon nitride (Si₃N₄), silicon oxynitride (SiON), hafnium oxide (HfO₂), zirconium oxide (ZrO₂), tantalum oxide (Ta₂O₃), titanium oxide (TiO₂), hafnium aluminum oxide (HfAlₓO_{y}), hafnium tantalum oxide (HfTaₓO_{y}), hafnium silicon oxide (HfSiₓO_{y}), aluminum nitride (AlₓN_{y}), and aluminum gallium nitride (AlGaₓN_{y}).

The blocking insulating film 546 may include at least one of silicon oxide (SiO₂), silicon nitride (Si₃N₄), silicon oxynitride (SiON), and a high-k dielectric layer. The blocking insulating film 546 may include a material having a higher dielectric constant than the tunneling insulating film 542. The high-k dielectric layer may include at least one of aluminum oxide (Al₂O₃), tantalum oxide (Ta₂O₃), titanium oxide (TiO₂), yttrium oxide (Y₂O₃), zirconium oxide (ZrO₂), zirconium silicon oxide (ZrSiₓO_{y}), hafnium oxide (HfO₂), hafnium silicon oxide (HfSiₓO_{y}), lanthanum oxide (La₂O₃), lanthanum aluminum oxide (LaAlₓO_{y}), lanthanum hafnium oxide (LaHfₓO_{y}), hafnium aluminum oxide (HfAlₓO_{y}), and praseodymium oxide (Pr₂O₃).

The gate electrode 552 may be on a right side surface of the gate dielectric film 540. A top surface and a bottom surface of the gate electrode 552 and a side surface of the gate electrode 552 toward the gate dielectric film 540 may be surrounded by an upper insulating film 545 and a barrier metal 552-1. The upper insulating film 545 may function as the gate dielectric film 540. For instance, the upper insulating film 545 may include an aluminum oxide film (i.e., alumina). Moreover, the barrier metal 552-1 may include tungsten nitride (WN), tantalum nitride (TaN), or titanium nitride (TiN), and/or tungsten silicide (WSi). For example, the gate electrode 552 may include titanium (Ti), tantalum (Ta), tungsten (W) and/or aluminum (Al).

The interlayer insulating films 562, 563 may be over and below the gate electrode 552. For example, each of the interlayer insulating films 562 and 563 may include silicon oxide.

During the manufacture of the semiconductor device SD, the upper insulating film 545, the gate electrode 552, and/or the barrier metal 552-1 may be sequentially stacked. A degree of deposition of each of the gate electrode 552 and/or the barrier metal 552-1 may need to be measured. The degree of deposition of each of the gate electrode 552 and/or the barrier metal 552-1 may be measured based on the thickness of each of the gate electrode 552 and/or the barrier metal 552-1.

As described above, the measuring system 10 may measure the thickness of each of the gate electrode 552 and/or the barrier metal 552-1 during the manufacture of the semiconductor device SD. The measuring system 10 may precisely measure a thickness of each of the plurality of material layers (e.g., the metal film ML).

The gate electrode 552 may correspond to the first metal film ML1 of FIG. 5, and the barrier metal 552-1 may correspond to the second metal film ML2 of FIG. 5. For example, the metal film ML of FIG. 5 may include the gate electrode 552 and/or the barrier metal 552-1.

A total resistance of the gate electrode 552 and/or the barrier metal 552-1 may be approximated to a resistance of the gate electrode 552. In addition, when a total thickness of a material film including the gate electrode 552 and/or the barrier metal 552-1 is obtained, a thickness of each of the gate electrode 552 and/or the barrier metal 552-1 may be calculated by using the resistance of the gate electrode 552.

The total thickness of the gate electrode 552 and/or the barrier metal 552-1 may be measured via a measuring method using a first laser beam, and the total resistance of the gate electrode 552 and/or the barrier metal 552-1 may be measured via a measuring method using a second laser beam.

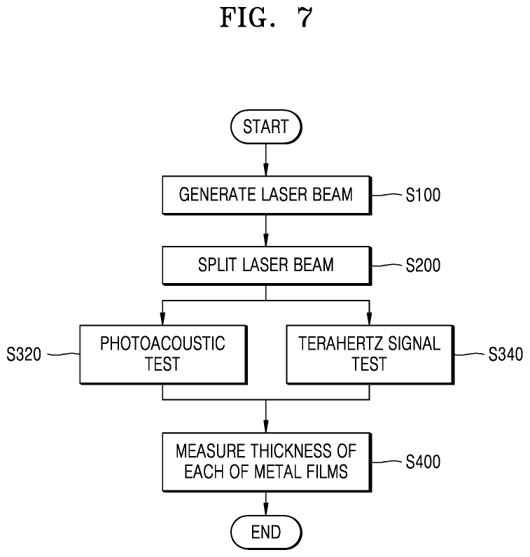

FIG. 7 is a flowchart of a method of measuring a wafer by using a measuring system. The flowchart of FIG. 7 is described with reference to FIGS. 1 to 6.

Referring to FIG. 7, to begin with, a source unit 100 may generate and emit a laser beam (S100). The source unit 100 may generate a femtosecond laser beam. Here, the laser beam may have a pulse length of about 0.1 fs to about 200 fs. Also, the laser beam generated by the source unit 100 may have a wavelength of about 300 nm to about 2000 nm.

Next, the laser beam generated by the source unit 100 may be split (S200). For example, a second probe laser beam may be split by the first beam splitter BS1, and a first probe laser beam may be split by the second beam splitter BS2. Also, a first pump laser beam and the second probe laser beam may be split by the third beam splitter BS3.

Thereafter, a photoacoustic test may be performed on a wafer 2000 due to the first probe laser beam and the first pump laser beam (S320).

To begin with, a behavior of the first probe laser beam is described. The first probe laser beam may be input from the second beam splitter BS2 to a first time-difference generator 210. The first time-difference generator 210 may delay and/or adjust a time taken for the first probe laser beam to enter a first detector 230. The first probe laser beam delayed and/or adjusted by the first time-difference generator 210 may be incident on an object lens 220.

The first probe laser beam, which has been transmitted through the object lens 220, may be reflected by the wafer 2000 and then incident on the first detector 230. The first detector 230 may generate an electrical signal in response to the first probe laser beam. An intensity and/or a phase of the first probe laser beam may change by ultrasonic waves. The first detector 230 may measure the intensity and/or phase of the first probe laser beam.

Next, a behavior of the first pump laser beam is described. The first pump laser beam, which has been transmitted through the second beam splitter BS2, may be incident on the third beam splitter BS3. The first pump laser beam may be transmitted through the third beam splitter BS3 and incident on a second time-difference generator 240.

The second time-difference generator 240 may delay and/or adjust a time taken for the first pump laser beam to enter the first detector 230. The first pump laser beam and a second pump laser beam may be temporally offset by the second time-difference generator 240. That is, a peak of a first laser beam and a peak of a second laser beam may be temporally spaced apart from each other by the second time-difference generator 240. In still another implementation, the first laser beam may be synchronized with the second laser beam by the second time-difference generator 240.

The first pump laser beam, which has been transmitted through the second time-difference generator 240, may be incident on an object lens 220. The first pump laser beam, which has been transmitted through the optical lens 220, may be incident on the wafer 2000. An ultrasonic signal may be generated by the first pump laser beam that is incident on the wafer 2000. As described above, the ultrasonic signal may change the intensity, phase, and/or frequency of the first probe laser beam.

A photoacoustic test may be performed on the wafer 2000 by using the first probe laser beam detected by the first detector 230. More specifically, a thickness of a metal film ML may be measured, based on the intensity, phase, and/or frequency of the first probe laser beam.

In addition, a terahertz signal test may be performed on the wafer 2000 due to the second probe laser beam and a second pump laser beam (S340).

To begin with, a behavior of the second probe laser beam is described. The second probe laser beam may be reflected by a first beam splitter BS1 and incident on the third time-difference generator 310. The third time-difference generator 310 may delay and/or adjust a time taken for the second probe laser beam to enter a second detector 320. The second probe laser beam delayed and/or adjusted by the third time-difference generator 310 may be incident on the wafer 2000. The second detector 320 may generate an electrical signal in response to the second probe laser beam.

Next, a behavior of the second pump laser beam is described. The second pump laser beam transmitted through the first beam splitter BS1 may be incident on the second beam splitter BS2. The second pump laser beam may be transmitted through the second beam splitter BS2 and incident on the third beam splitter BS3. The second pump laser beam may be reflected by the third beam splitter BS3 and incident on the mirror element 330. Thereafter, the second pump laser beam may be incident on the emitter 340, and the emitter 340 may generate a terahertz signal in response to the second pump laser beam.

The terahertz signal generated by the emitter 340 may be input to the wafer 2000, transmitted through the wafer 2000, and input to the second detector 320. The second detector 320 may detect the terahertz signal. The second detector 320 may measure a resistance of the metal film ML of the wafer 2000 by calculating an absorption rate of the terahertz signal.

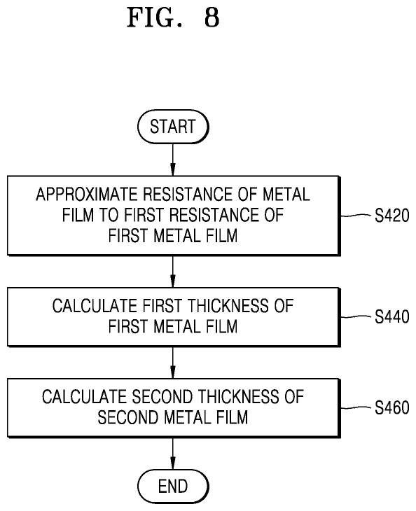

Afterwards, a thickness of each of a plurality of metal films ML may be obtained based on the resistance and the thickness of the metal film ML (S400). As described above, the thickness of the metal film ML may first be measured via the photoacoustic test, and the resistance of the metal film ML may be measured via the terahertz signal test. A method of measuring the thickness of each of the plurality of metal films ML is described in detail with reference to FIG. 8.

FIG. 8 is a flowchart of a method of measuring a thickness of each of a plurality of metal films. The flowchart of FIG. 8 is described with reference to FIGS. 1 to 7.

Referring to FIG. 8, to begin with, a resistance R of a plurality of metal films ML may be approximated to a first resistance R1 of a first metal film ML1 (S420). Because the first resistance R1 of the first metal film ML1 is much higher than a second resistance R2 of a second metal film ML2, the resistance R of the plurality of metal films ML may be approximated to the first resistance R1 of the first metal film ML1. Here, the first metal film ML1 may include a bulk metal, and the second metal film ML2 may include a barrier metal.

Thereafter, a first thickness T1 of the first metal film ML1 may be calculated based on the first resistance R1 of the first metal film ML1 (S440). Because a thickness of a metal has a linear proportional relationship with a resistance of the metal, the thickness of the metal may be calculated based on the resistance of the metal. Because the first resistance R1 of the first metal film ML1 is calculated in operation S420, the first thickness T1 may be calculated based on the first resistance R1.

Thereafter, a second thickness T2 of the second metal film ML2 may be calculated by calculating a difference between the thickness T of the metal film ML and the first thickness T1 of the first metal film ML1 (S460). That is, a thickness of each of the plurality of metal films ML may be measured.

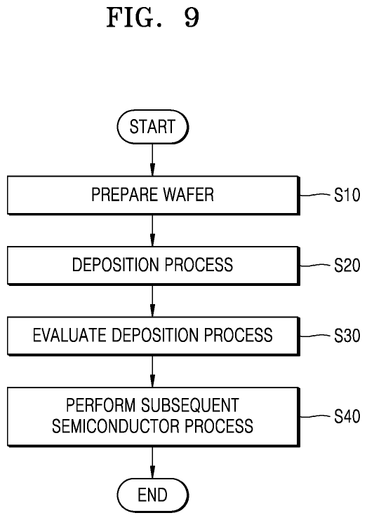

FIG. 9 is a flowchart of a method of manufacturing a semiconductor device, which includes a method of measuring a wafer by using a measuring system. The flowchart of FIG. 9 is described with reference to FIGS. 1 to 8.

Referring to FIG. 9, to begin with, a wafer 2000 may be prepared (S10). For example, various processes may have already been performed on the wafer 2000. For example, an oxidation process, a photolithography process, and/or an etching process may have been performed on the wafer 2000.

Thereafter, a deposition process may be performed on the wafer 2000 (S20). For example, a pattern having a plurality of metal films ML may be formed on the wafer 2000 by using the deposition process. The wafer 2000 may include a first metal film ML1 including a bulk metal and a second metal film ML2 including a barrier metal.

For example, the first metal film ML1 may include titanium (Ti), tantalum (Ta), tungsten (W) and/or aluminum (Al), and the second metal film ML2 may include tungsten nitride (WN), tantalum nitride (TaN), or titanium nitride (TiN), and/or tungsten silicide (WSi).

Thereafter, the deposition process may be evaluated (S30). The evaluation of the deposition process may include measuring a thickness of each of the plurality of metal films ML on the wafer 2000. That is, operation S30 may include an operation S100 of generating and emitting the laser beam of FIG. 7, an operation S200 of splitting the laser beam, an operation S320 of performing a photoacoustic test on the wafer 2000, an operation S340 of performing a terahertz signal test on the wafer 2000, and an operation S400 of measuring the thickness of each of the plurality of metal films ML.

After the deposition process is evaluated, a subsequent semiconductor process may be performed on the wafer 2000 (S40). The subsequent semiconductor process on the wafer 2000 may include various processes. For instance, the subsequent semiconductor process may include a deposition process, an etching process, an ion implantation process, a cleaning process, and the like. In addition, the subsequent semiconductor process may include a cutting process of dicing the wafer 2000 into respective semiconductor chips, a test process of testing the semiconductor chips, and a packaging process of packaging the semiconductor chips. A semiconductor device may be completed by performing the subsequent semiconductor process or processes on the wafer 2000. For example, the semiconductor device may include a memory device.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a combination can in some cases be excised from the combination, and the combination may be directed to a subcombination or variation of a subcombination.

While this disclosure has particularly shown a measurement system and described with reference to implementations thereof, it will be understood that various changes in form and details may be made therein without departing from the spirit and scope of the following claims.

What is claimed is:

1. A measuring system comprising:
a laser source configured to generate and output a laser beam;
a first pump-probe configured to receive the laser beam and perform a photoacoustic test on a measurement object;
a second pump-probe configured to receive the laser beam and perform a terahertz signal test on the measurement object; and
a stage configured to support the measurement object.

2. The measuring system of claim 1, wherein the laser beam incident on the first pump-probe comprises a first pump laser beam and a first probe laser beam,
wherein the first pump-probe unit comprises:
a first beam splitter configured to split the first pump laser beam and the first probe laser beam;
a first time-difference generator configured to delay the first probe laser beam; and
a first detector configured to detect the first laser beam.

3. The measuring system of claim 2, wherein the first time-difference generator is further configured to synchronize the first pump laser beam with the first probe laser beam.

4. The measuring system of claim 2, wherein the first detector is arranged to detect the first probe laser beam.

5. The measuring system of claim 1, wherein a laser beam incident on the second pump-probe unit is a second laser beam, and
the second laser beam comprises a second pump laser beam and a second probe laser beam, wherein the second pump-probe unit comprises:
a second beam splitter configured to split the second pump laser beam and the second probe laser beam;
a second time-difference generator configured to delay the second probe laser beam;
a laser emitter configured to receive the second pump laser beam and generate a terahertz signal; and
a second detector arranged to detect the second laser beam.

6. The measuring system of claim 5, wherein the second time-difference generator is configured to synchronize the second pump laser beam with the second probe laser beam.

7. The measuring system of claim 5, wherein the second detector is arranged to detect the terahertz signal and the second probe laser beam.

8. A measuring system comprising:
a laser source configured to generate and output a first laser beam and a second laser beam;
a first pump-probe configured to receive the first laser beam and perform a photoacoustic test on a measurement object;
a second pump-probe configured to receive the second laser beam and perform a terahertz signal test on the measurement object; and
a stage configured to support the measurement object,
wherein the first laser beam comprises a first pump laser beam and a first probe laser beam,
the second laser beam comprises a second pump laser beam and a second probe laser beam, and the second pump-probe comprises a first time-difference generator configured to delay the second pump laser beam from impacting a terahertz emitter.

9. The measuring system of claim 8, wherein the first time-difference generator is further configured to offset the second pump laser beam and at least one of the first pump laser beam or the first probe laser beam.

10. The measuring system of claim 8, wherein the first time-difference generator is further configured to synchronize the second pump laser beam with either the first pump laser beam or the first probe laser beam.

11. The measuring system of claim 8, wherein the first time-difference generator comprises a plurality of optical mirrors configured such that a delay time of the second pump laser beam is adjusted by linearly moving at least one of the plurality of optical mirrors.

12. The measuring system of claim 8, wherein the first pump-probe comprises a second time-difference generator configured to delay the first pump laser beam, and
the second pump-probe comprises a third time-difference generator configured to delay the second probe laser beam.

13. A measuring method comprising:
generating a laser beam;
splitting the laser beam into a first laser beam and a second laser beam;
performing a photoacoustic test on a measurement object using the first laser beam;
performing a terahertz signal test on the measurement object using the second laser beam; and
measuring a thickness of each metal film of a plurality of metal films of the measurement object based on a photoacoustic test result and on a terahertz signal test result.

14. The method of claim 13, wherein the first laser beam and the second laser beam are offset from each other in time.

15. The method of claim 13, wherein the first laser beam is synchronized with the second laser beam.

16. The method of claim 13, wherein measuring of the thickness of each of the plurality of metal films comprises:
measuring a thickness of the plurality of metal films via the photoacoustic test; and
measuring a resistance of the plurality of metal films via the terahertz signal test.

17. The method of claim 13, wherein the plurality of metal films comprises a bulk metal and a barrier metal, and
wherein measuring the thickness of each of the plurality of metal films further comprises approximating a resistance of the plurality of metal films by a resistance of the bulk metal.

18. The method of claim 17, wherein measuring the thickness of each of the plurality of metal films comprises:
calculating a thickness of the bulk metal based on the resistance of the bulk metal; and
calculating a thickness of the barrier metal based on the thickness of the bulk metal and on a thickness of the plurality of metal films.

19. The method of claim 13, wherein, when the first laser beam is incident on the measurement object, a photoacoustic signal is generated by the measurement object, and the thickness of the plurality of metal films is measured based on an intensity, a phase, or a frequency of a first probe laser beam that is changed due to the photoacoustic signal.

20. The method of claim 13, wherein, when a terahertz signal is transmitted to the measurement object, at least part of the terahertz signal is absorbed in the measurement object, and a resistance of the plurality of metal films is measured based on an absorption rate of the terahertz signal.
